(19) United States
(12) Patent Application Publication
(10) Pub. No.: US 2009/0180820 A1
(43) Pub. Date: Jul. 16, 2009

(54) Fuser device

(76) Inventors: Cheng-Wen Tsai, Dayuan Township (TW); Ming-Chun Hsu, Jhudong Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/149,799

(22) Filed: May 8, 2008

(30) Foreign Application Priority Data
Jan. 12, 2008 (CN) 200810025831.9

(51) Int. Cl. G03G 15/20

(52) U.S. Cl. 399/329

(57) ABSTRACT

A fuser device used with an imaging system for setting toner on a recording media is disclosed. The fuser device includes a heating element; a rolling piece for exerting pressure on the toner adhered on the recording media; a film for clamping the recording media with the rolling piece, the film being in the heat of the heating element to set the toner on the recording media; and a control structure. The control structure has a base piece on which a first engaging portion and a second engaging portion are disposed. The heating element, the first engaging portion and the second engaging portion form a loop and the film surrounds the loop.

### BACKGROUND OF THE INVENTION

1. Field of the Invention

The present invention relates to a fuser device used with an imaging system for setting toner on a recording media, and more especially to a fuser device which can tension a film based on a control structure.

2. Description of Related Art

Fuser devices are used in electronic imaging apparatus such as laser printers, copier and so on for setting toner, which is coated on thermally conductive thin films, on paper under proper pressure at proper temperature.

Please refer to FIG. 1 illustrating a fuser device for an imaging system disclosed in U.S. Pat. No. 5,525,775. The fuser device include a pressure roller 10a, a thin film guiding element 13 and a heater 19 disposed on a bottom of an insulating base 20a. The thin film guiding element 13 includes a flat-bottom portion 14, a front supporting wall 15 and a rear supporting wall 16. The front supporting wall 15 and the rear supporting wall 16 extend longitudinally from two ends of the flat-bottom portion 14 respectively and are arc-shaped. A thermally conductive thin film 21a covers the thin film guiding element 13.

When printing, the pressure roller 10a turns in the anticlockwise direction and drives the thermally conductive thin film 21a to turn in the clockwise direction, thereby driving paper P to pass through the fuser area between the heater 19 and the pressure roller 10a. The heater 19 gives out heat and transfers the heat to the paper P and the toner Ta through the thermally conductive thin film 21a after electrodes (not shown) of the heater 19 are electrified. Under the influence of the heat and the pressure from the pressure roll 10a, the toner Ta melts to be set on the paper P.

In the course of printing, the thermally conductive thin film 21a contacts with the front supporting wall 15 in an area B. The contact in the large area causes the wear of the thermally conductive thin film 21a relative to the thin film guiding element 13.

Additionally, the thermally conductive thin film 21a is affected by the tensile force only in the area A and the area B, and is in the tension relaxation state in the other areas. Since the tensile force on the thermally conductive thin film 21a varies, the movement of the thermally conductive thin film 21a is unstable, so that the portion of the thermally conductive thin film 21a which contacts with the paper P has unstable dynamic characteristics when it enters and leaves the fuser area, which affects the set quality of the toner. Also, the contact force between the thermally conductive thin film 21a and the thin film guiding element 13 is unstable, so the thermally conductive thin film 21a and the thin film guiding element 13 collide with each other, thereby their wear increases.

### SUMMARY OF THE INVENTION

An object of the present invention is to provide a fuser device used with an imaging system for setting toner on a recording media. The fuser device includes a control structure, and controls tension force of a thin film via the control structure to maintain contact force between the thin film and its supporting elements, so that the thin film can keep in a stable operating state during heating and printing to improve the print image quality and solve the problem that the set quality of the toner is affected by the wear of the thin film and the unstable state of the thin film caused by its tension force.

To achieving the above-mentioned object, a fuser device in accordance with the present invention is provided. The fuser device includes a heating element; a rolling piece for exerting pressure on the toner adhered on the recording media; a film for clamping the recording media with the rolling piece, the film being in the heat of the heating element to set the toner on the recording media; and a control structure having a base piece on which a first engaging portion and a second engaging portion are disposed, wherein the heating element, the first engaging portion and the second engaging portion form a loop and the film surrounds the loop.

Preferably, a connecting portion is disposed on the base piece, and the second engaging portion is located between the first engaging portion and the connecting portion; and the control structure further includes an elastic piece coupled with the connecting portion and the imaging system for exerting pressure on the base piece and controlling the contact force between the film and the heating element, and between the first engaging portion and the second engaging portion.

Preferably, the elastic piece is a spring.

Preferably, the first engaging portion is rotatably disposed on the base piece.

Preferably, the second engaging portion is rotatably disposed on the base piece.

Preferably, the first engaging portion has a flange protruding from a free end thereof.

Preferably, the second engaging portion has a flange protruding from a free end thereof.

Preferably, the heating element is a halogen lamp or a ceramic heater.

In the present invention, the elastic piece tensions the base piece based on a certain force all the time in order that the contact force between the thin film and the first engaging portion, the second engaging portion and the thermally conductive sleeve remains constant during printing, thereby the thin film keeps in a stable operating state during heating and printing to improve the print image quality. Furthermore, the contact area between the thin film and the first engaging portion and the second engaging portion is relative small, so the friction therebetween is reduced during the movement of the thin film and the wear of the thin film is reduced.

### BRIEF DESCRIPTION OF THE DRAWINGS

FIG. 1 is a schematic view of a conventional fuser device;

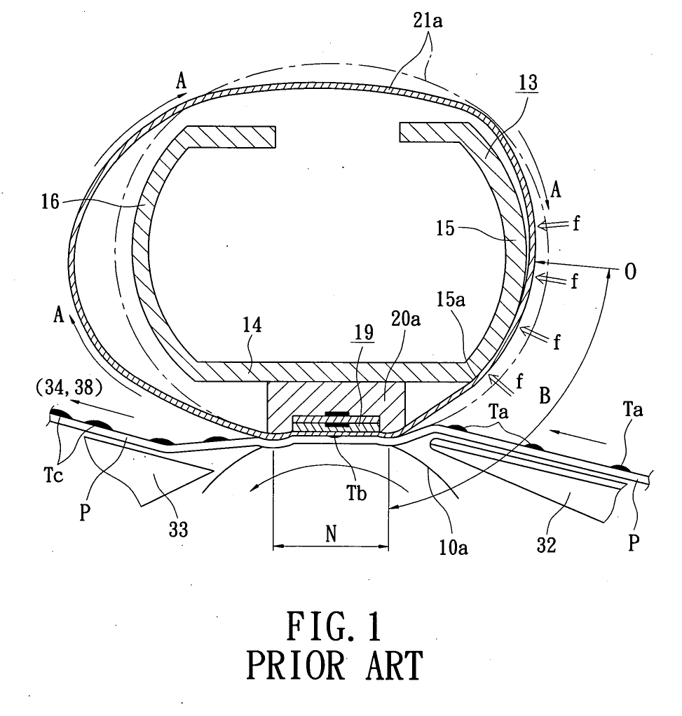

FIG. 2 is a perspective view of a preferred embodiment of a fuser device according to the present invention;

FIG. 3 is an exploded perspective view of the preferred embodiment of the fuser device according to the present invention;

FIG. 4 is a cross-sectional view of the preferred embodiment of the fuser device with a control structure according to the present invention;

FIG. 5 is an exploded perspective view of another preferred embodiment of the fuser device with a control structure according to the present invention; and

FIG. 6 is a cross-sectional view of the preferred embodiment of the fuser device according to the present invention, illustrating two positions of an elastic piece.

### DETAILED DESCRIPTION OF THE PREFERRED EMBODIMENTS

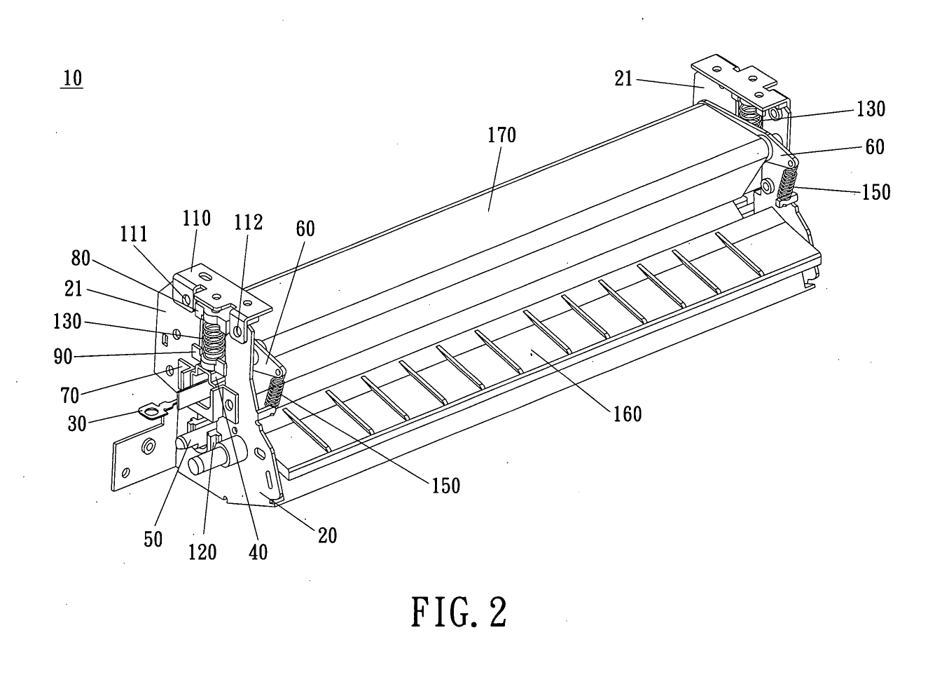

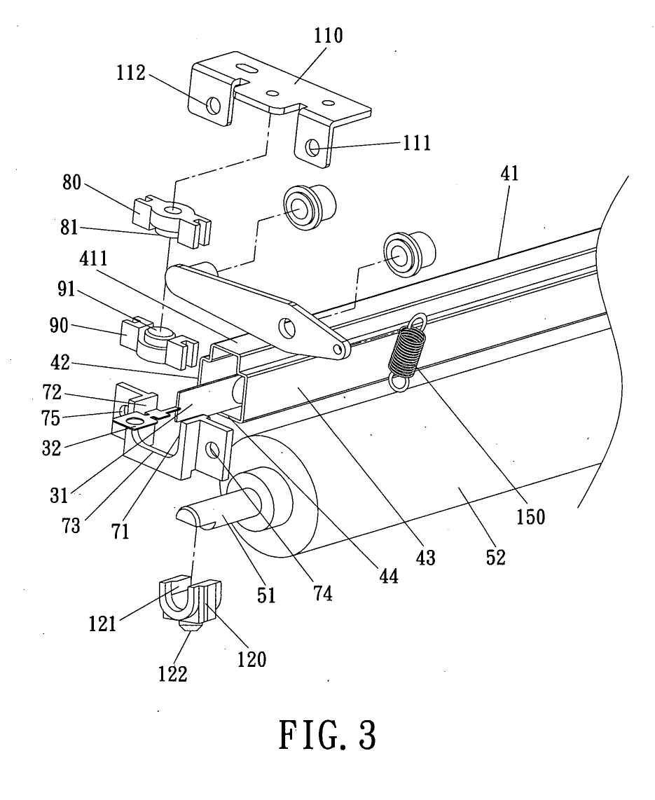

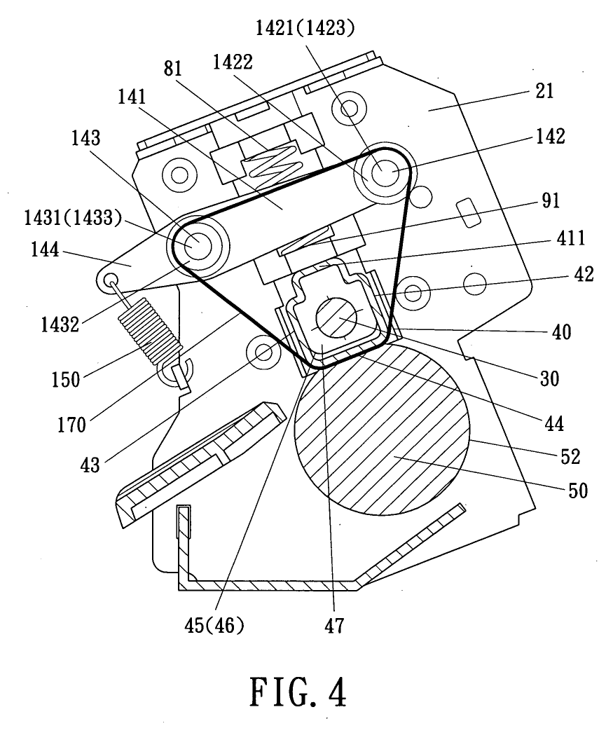

FIG. 2, FIG. 3 and FIG. 4 respectively show a perspective view, an exploded perspective view and a cross-sectional view of a preferred embodiment of a fuser device according to the present invention. The fuser device 10 includes a support 20, a heating element 30, a thermally conductive sleeve 40, a pressure roller 50, a thin film 170 and a control structure 60.

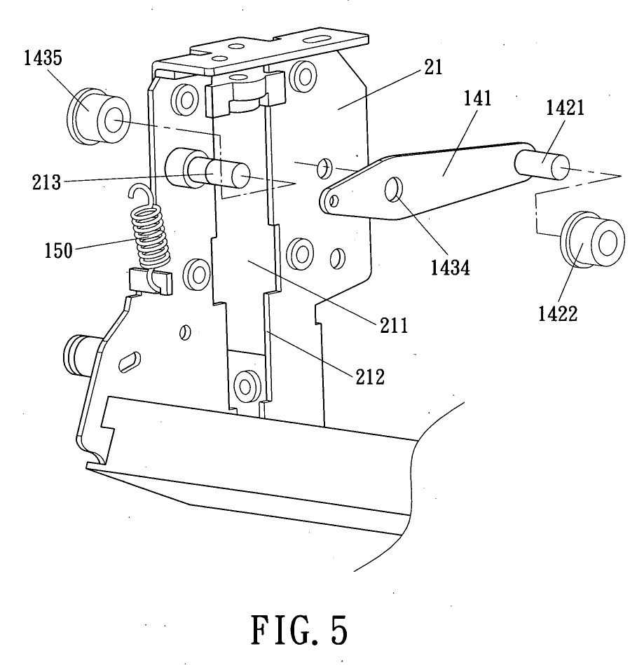

The support 20 includes two side boards 21 which are disposed relative to each other for positioning of the thermally conductive sleeve 40 and the control structure 60. Each side board 21 has a slot 211 and an inner wall 212 defining the slot 211 (as shown in FIG. 5)

The thermally conductive sleeve 40 is made of aluminium alloy material and disposed on the support 20. The thermally conductive sleeve 40 has the shape of a hollow long strip and includes a casing wall 41, two locating surfaces 42, 43, a contact surface 44, two end faces 45, 46 located on the ends thereof and a receiving space 47 defined by the casing wall 41, the two locating surfaces 42, 43 and the contact surface 44. The casing wall 41 has a horizontal colliding surface 411. The two locating surfaces 42, 43 are respectively located on the left side and the right side of the casing wall 41 relative to each other and extend from the middle portion to the two sides. The contact surface 44 is connected with the two locating surfaces 42, 43 under the casing wall 41. When the thermally conductive sleeve 40 is located in the thin film 170, the contact face 44 abuts against the inner surface of the thin film 170.

The pressure roller 50 includes two contact portions 51 and a pivot shaft 52. The two contact portions 51 are respectively disposed on two ends of the pivot shaft 52 and the pivot shaft 52 passes through the slots 211 in the side boards 21 adjacent to the bottom of the slots 211, whereby the pressure roller 50 is disposed on the support 21. The pressure roller 50 may be driven to turn by a motor (not shown), and then drive the thin film 170 to turn.

The heating element 30 may be a halogen lamp and disposed in the receiving space 47 of the thermally conductive sleeve 40. The heating element 30 includes a long lamp portion 31 and two electrode portions 32. The lamp portion 31 is received in the receiving space 47 and the two electrode portions are disposed on the two ends of the lamp portion 31 and extend out of the thermally conductive sleeve 40. Two power lines (not shown) are respectively connected with the two electrode portions 32 for providing wording power, so that the lamp portion 31 can heat the thermally conductive sleeve 40 via radiation heating. Alternatively, the heating element 30 may be also a ceramic heater and isn't limited in the design of the halogen lamp in the embodiment.

The fuser device 10 further includes two blocking pieces 70, two upper locating pieces 80, two lower locating pieces 90, two top boards 110, two bearings 120 and two elastic pieces 130. Each blocking piece 70 includes two contact lateral faces 71, 72, a step face 73 and two through-holes 74, 75, wherein the two contact lateral faces 71, 72 respectively contact with the two locating surfaces 42, 43 of the thermally conductive sleeve 40 to limit the longitudinal displacement of the thermally conductive sleeve 40; the step face 73 abuts against the end faces 45, 46 of the thermally conductive sleeve 40 to limit the transverse displacement of the thermally conductive sleeve 40; and the blocking piece 70 is connected with the corresponding side board 21 via the two through-holes 74, 75. Each upper locating piece 80 has a horizontal contact surface 81 formed on the bottom thereof. Each lower locating piece 90 has a horizontal colliding surface 91 formed on the upper surface thereof. The top board 110 includes two through-holes 111, 112 for connecting the top board 110 with the corresponding side board 21. Each bearing 120 includes an inner wall 121 abutting against the corresponding contact portion 51 of the pressure roller, and a contact surface 122 formed on the bottom of the bearing 120. The contact surface 122 abuts against the slot 211 of the corresponding side board 21. Each elastic piece 130 is a compression spring for exerting pressure on the thermally conductive sleeve 40, of which two ends respectively abut against the colliding surface 91 of the lower locating piece 90 and the contact surface 81 of the upper locating piece 80.

As shown in FIG. 4 which is a cross-sectional view of the preferred embodiment of the fuser device, the control structure 60 includes a base piece 141, a first engaging portion 142, a second engaging portion 143 and a connecting portion 144.

Refer to FIG. 5 simultaneously, the first engaging portion 142 may be a first supporting shaft 1421 protruding from the base piece 141 or a first supporting rolling wheel 1422 rotatably disposed on the base piece 141. When the first engaging portion 142 is the first supporting rolling wheel 1422, the base piece 141 has a protruding shaft 1423 passing through the first supporting rolling wheel 1422. The second engaging portion 143 has a similar structure to the first engaging portion 142 and may be also a second supporting shaft 1431 protruding from the base piece 141 or a second supporting rolling wheel 1432 rotatably disposed on the base piece 141. When the second engaging portion 143 is the second supporting rolling wheel 1432, the base piece 141 has a protruding shaft 1433 passing through the second supporting rolling wheel 1432.

Regardless of the structures, the supporting shaft or the supporting rolling wheel has a flange protruding from the free end thereof, which has a circumference greater than that of the supporting shaft or the supporting rolling wheel, thereby protecting the thin film 170 from sliding down during rotation.

As shown in FIG. 5 which is a partially schematic view of an embodiment of the fuser device with the control structure, the second engaging portion 143 may has a hole 1434 and a shaft 213, wherein the hole 1434 is formed in the base piece 141 and the shaft 213 is disposed on an imaging system, corresponding to the hole 1434, and the base piece 141 is disposed on the shaft 213 via the engagement of the hole 1434 and the shaft 213. The second engaging portion 143 may also has a hole 1434 and a rolling wheel 1435, wherein the hole 1434 is formed in the base piece 141 and the rolling wheel 1435 is disposed on the imaging system, corresponding to the hole 1434, and the base piece 141 is disposed on the rolling wheel 1435 via the engagement of the hole 1434 and the rolling wheel 1435. When the second engaging portion 143 has the hole 1434 and the rolling wheel 1435, the rolling wheel 1435 may be disposed in the hole 1434 so that the outer surface of the rolling wheel 1435 contacts with the hole 1434; or, extend from the hole 1434 so that the end face of the rolling wheel contacts with the base piece 141. Each of the shaft 213 and the rolling wheel 1435 has a flange protruding therefrom, which has a circumference greater than that of the shaft 213 or the rolling wheel 1435.

In the fuser device of the present invention, the heating element 30, the first engaging portion 142 and the second engaging portion 143 form a loop, and the thin film 170 surrounds the loop, that is, surrounds the heating element 30, the first engaging portion 142 and the second engaging portion 143 in a relaxation state, and the two ends of the thin film 170 abut against the base portion respectively. However, during the rotation of the thin film 170, the tensile force on the thin film 170 varies, so that the movement of the thin film 170 is unstable, and the paper has unstable dynamic characteristics when it passes through the fuser area, which affects the set quality of the toner. Further, the contact force between the thin film 170 and the first engaging portion 142 and the second engaging portion 143 is unstable, so the thin film 170 and the first engaging portion 142 collide with each other, thereby the wear degree of the thin film 170 increases.

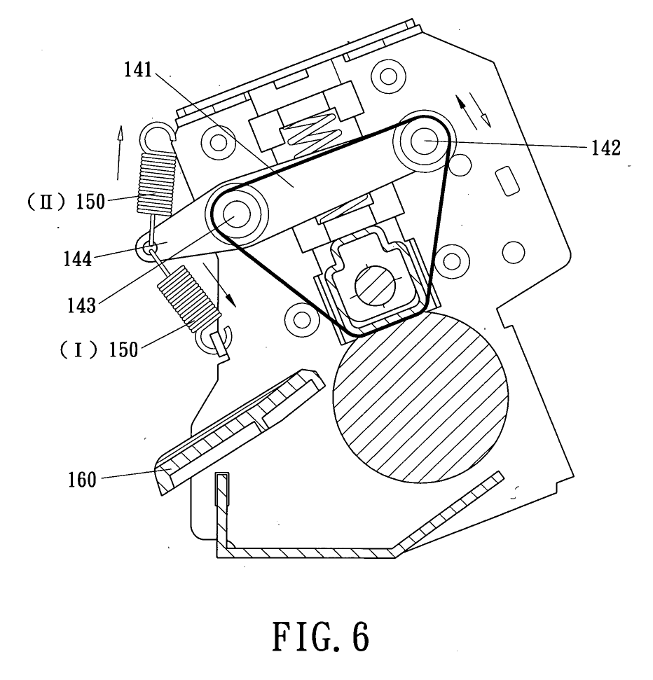

Accordingly, as shown in FIG. 6 which is a cross-sectional view of the preferred embodiment of the fuser device, the control structure 60 further includes an elastic piece which is a spring 150 disposed on position I. The spring 150 is disposed on the connecting portion 144 of the base piece 141 and the imaging system in a pulled state. Based on the tension force of the spring 150, the end of the base piece 141 adjacent to the second engaging portion 143 moves along the side adjacent a paper feeding surface 160 and the other end moves in the opposite direction (the direction of the solid arrow as shown in the figure), thereby the whole loop becomes longer and the thin film 170 is tensioned.

Besides, the spring 150 may be also disposed on position II, then the end of the base piece 141 adjacent to the second engaging portion 143 moves on the side far away from the paper feeding surface 160 and the other end moves in the opposite direction (the direction of the hollow arrow as shown in the figure), thereby the whole loop becomes longer and the thin film 170 is also tensioned.

As shown in FIG. 4, when printing, the pressure roller 50 rotates in the anticlockwise direction and drives the thin film 170 to move in the clockwise direction, thereby driving a piece of paper (not shown) to pass through the fuser area between the contact surface 44 of the thermally conductive sleeve 40 and the pressure roller 50. In the course of the paper and the toner passing through the fuser area, the heat from the heating element 30 is transferred to the thin film 170 through the thermally conductive sleeve 40 to heat the paper and the toner. When heated to a certain temperature, the toner melts, and then is set on the paper under the effect of the contact force between the thin film 170 and the pressure roller 50.

In the process, the spring 150 tensions the base piece 141 based on a certain force all the time in order that the contact force between the thin film 170 and the first engaging portion 142, the second engaging portion 143 and the thermally conductive sleeve 40 remains constant, thereby the thin film 170 keeps in a stable operating state during heating and printing to improve the print image quality. Furthermore, the contact area between the thin film 170 and the first engaging portion 142 and the second engaging portion 143 is relative small, so the friction therebetween is reduced during the movement of the thin film 170 and the wear of the thin film 170 is reduced.

The present invention connects the elastic piece (that is, the spring 150) between the base piece 141 and the imaging system and drives the base piece 141 based on the elastic force caused by the deformation of the elastic piece to tension the thin film 170 and maintain the contact force between the thin film 170 and the base piece 141, so that the thin film 170 can keep in the stable operating state during heating and printing, thereby improving the print image quality.

What is claimed is:

1. A fuser device used with an imaging system for setting toner on a recording media, comprising:
a heating element;
a rolling piece for exerting pressure on the toner adhering on the recording media;
a film for clamping the recording media with the rolling piece, the film being in the heat of the heating element to set the toner on the recording media; and a control structure, having a base piece on which a first engaging portion and a second engaging portion are disposed, wherein the heating element, the first engaging portion and the second engaging portion form a loop and the film surrounds the loop.

2. The fuser device as claimed in claim 1, wherein a connecting portion is disposed on the base piece, and the second engaging portion is located between the first engaging portion and the connecting portion; and the control structure includes an elastic piece coupled with the connecting portion and the imaging system for exerting pressure on the base piece and controlling the contact force between the film and the heating element, and between the first engaging portion and the second engaging portion.

3. The fuser device as claimed in claim 2, wherein the elastic piece is a spring.

4. The fuser device as claimed in claim 1, wherein the first engaging portion is rotatably disposed on the base piece.

5. The fuser device as claimed in claim 1, wherein the second engaging portion is rotatably disposed on the base piece.

6. The fuser device as claimed in claim 1, wherein the first engaging portion has a flange protruding from a free end thereof.

7. The fuser device as claimed in claim 1, wherein the second engaging portion has a flange protruding from a free end thereof.

8. The fuser device as claimed in claim 1, wherein the heating element is a halogen lamp or a ceramic heater.
